(19) United States
(12) Patent Application Publication
(10) Pub. No.: US 2010/0027212 A1
(43) Pub. Date: Feb. 4, 2010

(54) ENVIRONMENTAL DISASTER DATA PROTECTION SYSTEM

(75) Inventor: Enrique Daunert Armillas, Sant Cugat del Vallés (ES)

Correspondence Address: PEARNE & GORDON LLP, 1801 EAST 9TH STREET, SUITE 1200, CLEVELAND, OH, 44114-3108, US

(73) Assignee: ADVANCED SHIELDING TECHNOLOGIES EUROPE S.L., Cornellá de Llobregat (ES)

(21) Appl. No.: 12/505,106

(22) Filed: Jul. 17, 2009

Related U.S. Application Data
(60) Provisional application No. 61/081,471, filed on Jul. 17, 2008.

(51) Int. Cl. G06F 1/16; G06F 1/20

(52) U.S. Cl. 361/679.33; 361/679.31; 361/679.46

(57) ABSTRACT

A data protection system is provided that allows secure storage and back-up of data and that protects this information physically from environmental disasters and further allows recovery of all the stored data fast and effectively. The data protection system offers total physical protection against any major disaster, such as fire, flood, vandalism, theft, building collapse and electromagnetic radiation in part by an online monitoring system that facilitates remote management, control, and detection of various environmental and system parameters. When such parameters are detected outside of a preset range or value, an alarm or alert can be triggered or sent and various actions can be performed automatically by the system in order to immediately protect the stored data from damage, tampering, or theft. The system is modular and scalable to meet different data storage needs as well as different space restrictions.

### CROSS-REFERENCE TO RELATED APPLICATION

This application claims the benefit of U.S. Provisional Application Ser. No. 61/081,471 entitled ENVIRONMENTAL DISASTER DATA PROTECTION SYSTEM and filed on Jul. 17, 2008, the entirety of which is incorporated herein by reference.

### BACKGROUND

Regardless of their size, businesses rely on their data to maintain their operations. Compromises to their data can result in both tangible financial losses as well as intangible losses that may affect the business for an unknown or extended amount of time.

### SUMMARY

The subject application relates to a data protection system that allows secure storage and backup of data and that protects this information physically from environmental disasters and allows recovery of all the stored data fast and effectively. In particular, the data protection system offers total physical protection against any major disaster, such as fire, flood, vandalism, theft, building collapse and electromagnetic radiation and monitoring and control of the system from a remote location.

The data protection system includes a Network Attached Storage (NAS) with several disks in order to backup large amounts of data using a network cable. In particular, the data protection system includes storage capacity such as 4 TB of disk space. Also included are an integrated modem or other device to facilitate a network connection (e.g., to send email and SMS alerts), a data board to control environmental parameters (such as temperature, relative humidity and vibration) and monitoring software to remotely view and control the data protection system status, disks back-up status, and parameters relating to both.

According to an aspect of the application, a data protection device is provided which comprises an external frame; at least one internal frame positioned inside of the external frame; a plurality of layers comprising microporous material located between the external frame and the at least one internal frame such that the material fills the space between the external frame and the at least one internal frame; a data storage system that is located within the at least one internal frame and that backs up data; and an online remote monitoring system located within the at least one internal frame that comprises a plurality of sensors and a data board, wherein the data board is connected to the plurality of sensors and wherein the data board remotely monitors in real-time at least one of the following parameters: temperature, back-up status and activity, access activity, relative humidity, vibration, fan speed, power supply, air quality, smoke, moisture, door status, lock status, ventilation duct status, electromagnetic radiation level, and system mode.

### BRIEF DESCRIPTION OF THE DRAWINGS

FIG. 1 is a front-side view of an exemplary data protection system, whereby the front panel cover is open to expose a portion of the interior components.

FIG. 2 illustrates the outer and inner structures of the data protection system.

FIG. 3 illustrates an interior view of the data protection system.

FIG. 4 is a schematic representation depicting interior layers of materials included in the data protection system of FIG. 1.

FIG. 5 illustrates an interior view of the data protection system of FIG. 1.

FIG. 6 is a schematic representation of an interior portion of the data protection system.

FIG. 7 is a schematic representation of an insulating plug portion located in the interior of the data protection system.

FIG. 8 is a schematic representation of an interior portion of the data protection system.

FIG. 9 is an exemplary user interface employed by a remote monitoring computer system that monitors environmental parameters of the data protection system of FIG. 1.

FIG. 10 is an exemplary user interface employed by a remote monitoring computer system that monitors the state of data backups performed by the data protection system of FIG. 1.

FIG. 11 is an exemplary user interface employed by a remote monitoring computer system that monitors the state of hardware components the data protection system of FIG. 1.

FIG. 12 is an exemplary user interface employed by a remote monitoring computer system that provides an activity log in connection with the data protection system of FIG. 1.

### DETAILED DESCRIPTION

Fire, building collapse, flooding, electromagnetic radiation, theft and/or vandalism are real threats to any company's data and any business survival. In order to solve this real threat, the data protection system offers a total physical protection against any major disaster, allows enough data storage capacity for any small or medium business and it is compatible with any backup software.

The Network Attached Storage (hereinafter “NAS”) inside of the data protection system provides the most reliable data backup in RAID 5 (redundant array of independent disks) array which means that 1 out of the 5 disks is redundant. In the event of any major disaster, the backup data is saved inside of the data protection system and the company can replicate its files server and data, guaranteeing the business continuity.

The data protection system protects the company's most critical asset: their data and provides the fastest speed of data recovery and gives the highest storage capacity. All of these advantages aim to guarantee and maintain business continuity for any company.

The data protection system makes affordable to all small and medium businesses, local authorities or professional organizations a smaller, more compact data centre that take advantage of all the benefits of the bigger scale data centres. Some of the main advantages of the data protection system include but are not limited to the following:
Ideal for small and medium businesses, local authorities, professional organizations or bigger companies with office in different locations.
Total physical protection against fire, flood, vandalism, theft, building collapse and electromagnetic radiation.
It offers as standard up to a 4 TB capacity with 5 disks in RAID 5.
As the data backup is stored in disks, it is the quickest way to recover the data, which is paramount for the business continuity.
Its remote monitoring allows controlling externally the data protection system environmental parameters.
Backup system in disk format is much more reliable than the old system of backup tapes.
Its integrated modem sends email or SMS alerts in case any environmental parameters are outside the preset range or if any alarm is triggered.
It is a cost effective data backup solution for regulatory compliance with the new Data Protection Acts.
17″ wide which allows it to be fitted inside any standard 19″ IT rack.
It is modular and scalable to fit larger organizations.
It is very easy to use and install.
It is made of heavy-duty equipment.

To securely backup the company's data is part of any business disaster recovery practice. However, to ensure real business disaster recovery, the reliability of the backup is paramount. Traditional solutions such as DLT tapes cannot guarantee it, as they are unreliable, corruptible, have low capacity of storage and data is very slow to recover.

### Protection Against Fire

A test was carried out to check the data protection system resistant against fire. A hard drive was put inside the data protection system prototype. According to the heating curve of EN1047-1, the furnace reached 950° C. in 60 minutes, while the temperature inside the data protection system remained below 50° C., ensuring the survival of the backup data. After the cooling process finished, the hard disk was taken out of the data protection system prototype and the files were retrieved successfully from the hard drive.

### Protection Against Data Loss

The data protection system acts as an active safe. In case of any major disaster or if any of the environmental parameters are outside of the preset values, it will close itself down in order to guarantee the survival of the backup data stored inside. The data protection system allows any small or medium businesses to recover the company's stored information much quicker than any other backup system, guaranteeing that the company can go on with its daily activities minimizing the effect of any major data loss. The data protection system is much more reliable than the commonly used backup tapes, as it protects physically the stored data and guarantees immediate access to this data, enabling the end user to resume its commercial activities with a minimum downtime.

### Protection With Online Monitoring

The data protection system incorporates software to provide unique online monitoring system. With this software and a data board, any IT Manager will be able to check via an IP address the main environmental parameters of the device, which can be connected in one or several remote locations.

The online access to the data protection system provides real-time graphs and monitoring of the main environmental parameters. In the event of any environmental parameters exceeding the preset values regarding temperature, relative humidity, vibration, unauthorized access or backup failure, the data protection system sends an alarm by SMS or email, before shutting down. With the online monitoring system, the real-time state of the data backup can be monitored as well, allowing the end users to check not only the capacity used in each disk or storage format, but to make sure that the most recent backup(s) have been done properly.

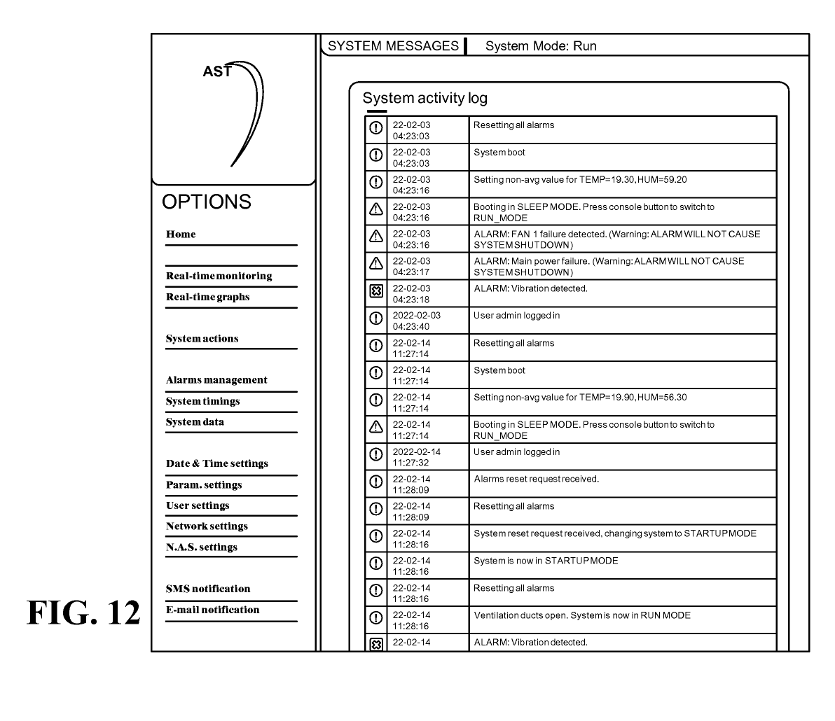

One particular advantage of this remote monitoring software is the daily activity log. An exemplary user interface of the daily activity log is depicted in FIG. 12. Within this activity log are recorded all the daily actions of the data protection system in real time. It is a priceless amount of information for any end user or IT Manager, as it displays the following kinds of information, including but not limited to: all alarms which have occurred; when the doors were opened and closed; when the alarms were reset; who authorized any of these actions; and the system mode (RUN, SLEEP, TEST, SHUT DOWN, etc . . . )

### Protection of Personal Data

Tighter data regulatory compliance has been developed in recent years in both the European Union and the United States—as evidenced by Article 17 of the Directive 95/46 of the European Parliament which refers to the processing of personal data and on the free movement of such data; and the HIPAA and Sarbanes-Oxley Acts for the healthcare and financial sectors. The data protection system can be set up to restrict the access to the stored data (especially for local authorities and professional organizations), helping the clients to comply with these latest Data Protection Acts. This legal compliance does not only affect professional organizations or local authorities, as all businesses or government bodies need a solid data backup and recovery plan.

As the European Directive requests, the data protection system ensures “a level of security appropriate to the risks represented by the processing of the data to be protected ”. The data protection system can incorporate additional features as finger print and eye recognition software to further restrict access to the stored data. As an efficient and reliable tool to control and monitoring the stored data, the data protection system will record in a daily report the identities of those who have had access to the stored data.

### Cooling Performance

Any IT equipment generates heat. The data protection system has been developed to protect the back-up data against the threat of an external fire. In order to cool down the internal box, an improved air flow system has been developed. The data protection system incorporates 6 fans in total: 1 at the front, under the front cover; 2 inside, underneath the tray, blowing cooled air to the front of the NAS; 2 inside, at the rear, sucking hot air from the back of the NAS; and 1 at the back, under the rear cover. This system provides efficient air flow through the data protection system, even with the door closed, guaranteeing ideal and desired environmental conditions regarding air temperature inside of the box.

The following test was carried out for a 10-hour period, in order to measure the internal temperature and the performance of the 6 fans. The environment temperature was determined to be an average 21.1° C., the temperature at the front fans was an average 23.8° C., and the temperature at the rear fans was an average 25.2° C. The internal temperature of the box was higher at the rear of the NAS, where the rear fans sucked the hot air out. However the temperature remained constant between 22° C. and 26° C., which is an optimal temperature for any IT equipment.

Another test was carried out to check if a high room temperature would have any effect on the internal cooling. For that purpose, hot air was blown into the data protection system at an average temperature of 32.8° C. The temperature at the front fans was determined to be an average 27.9° C. and the temperature at the rear fans was an average 32.8° C. In the event that room temperature is abnormally high, the cooling system inside of the data protection system provides an optimal cooling. The internal temperature remained way below the maximum allowed temperatures to guarantee and ensure survival of the data.

An additional test was carried out to check out the cooling performance when the disks inside the NAS are backing up the data. This is the moment where the NAS might have a higher temperature, which is realistic for any customer who operates this kind of equipment. This test was carried out for a 7-hour period. The environment temperature was average 18.8° C., the temperature at the front fans was an average 19.9° C., and the temperature at the rear fans was an average 28° C. At the peak of the NAS performance, that is, with all disks backing up, the NAS temperature remained below 39° C. , while the disks temperature remained under 37° C. Considering that the maximum temperature for IT equipment should remain well under 50° C., the results demonstrate that even when the NAS and the disks are working at their 100% full capacity, the cooling system keeps the internal temperature in optimal conditions for backing up the data and guaranteeing its survival and integrity.

A final test was carried out to observe the cooling performance when the Phase Changing Material Packs were fitted inside the data protection system and the NAS was backing up the data. As before, this is the moment where the NAS might have a higher temperature, which is a realistic scenario for any customer who is running this kind of equipment. The final test was carried out for a 6-hour period. The environment temperature was an average 22.1° C., the temperature at the front fans was an average 22.6° C., and the temperature at the rear fans was an average 28.9° C. The data protection system can also operate to protect against vandalism, water and smoke, electromagnetic radiation, and the like.

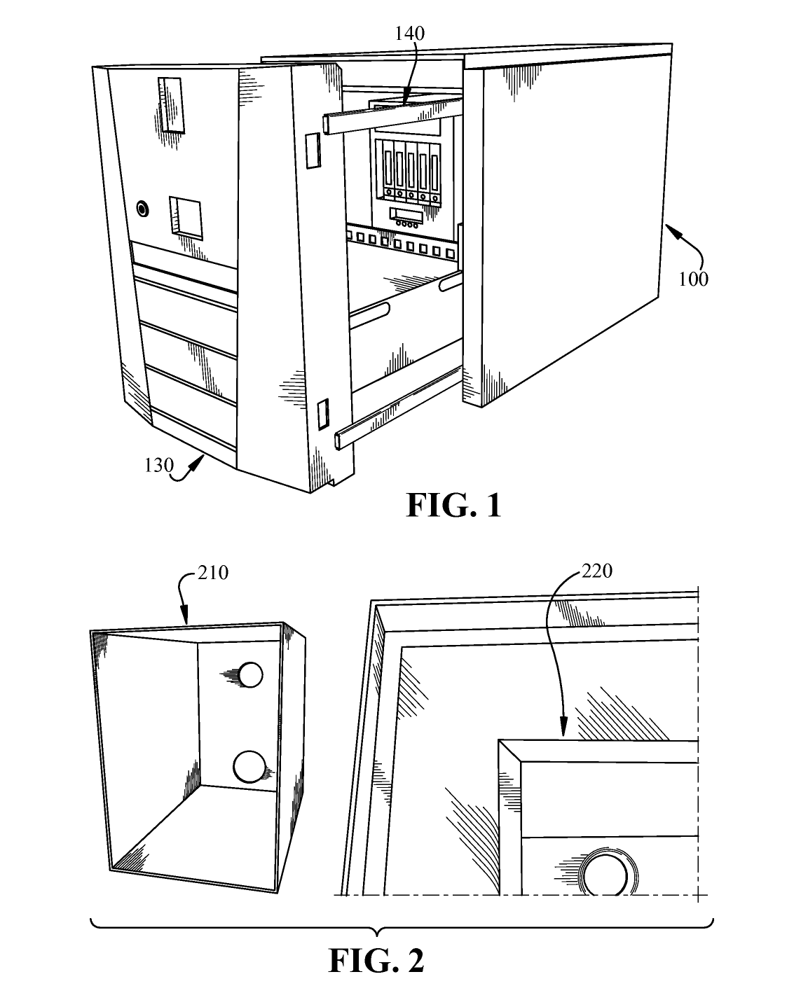

Turning now to FIGS. 1-11, an exemplary data protection system 100 is illustrated. At the back of the product, behind the back cover, are located the electronic components including but not limited to the power supply, 2 electromagnetic locks, embedded PC Linux, modem, flooding sensor, smoke detector and rear fan. These components are connected to the front of the data protection system, where the data board is located. The data board stores environmental parameters and signals, which are managed by the embedded PC Linux. The software constantly reads the smoke and flood detectors, sensors, microswitches, thermostat, electromagnetic locks and fans rotation. In the event of any abnormal parameters, the data protection system goes into shut-down mode, protecting the back-up information stored inside.

Once the shut-down conditions have been detected, the data protection system sends an alarm via SMS and/or email, for example, to the system administrator or other designated recipient. In that mode, the fans will stop rotating and the internal mechanical device locks the air flow openings. The power supply switches off, and the data protection system shuts down.

The normal operation of the data protection system is with the door closed, guaranteeing the total physical protection against any external threat. However the air flow openings are kept open, in order to allow a constant flow of cool air through the NAS. The NAS is given as standard with the data protection system. It includes the remote monitoring software and 5 Seagate disks with 750 GB capacity each. This IT equipment is connected to the customer's network through a network cable located at the rear of the box. Depending on the back-up policy and software from each customer, the NAS will back-up in real time either the customer's files and folders or their operating system or both.

### Description of the Main Structural Components

The data protection system device 100 (FIG. 1) comprises at least two stainless steel rectangular frames as shown in FIG. 2, where the smaller interior frame 220 fits inside the bigger external frame 210. These rectangular frames give rigidity to the overall system 100 and protect both the locking mechanism and the back-up device. The cover or door 130 is attached to the external frame 210 by two pairs of sliding guides 140, which will link this door 130 to the main body 210 of the data protection system 100. On top of this cover 130 there is a front panel, where all the following items are located: logo, an LCD screen, an open/close door button, a handle to open/close the door, and a grill plate for the front fan.

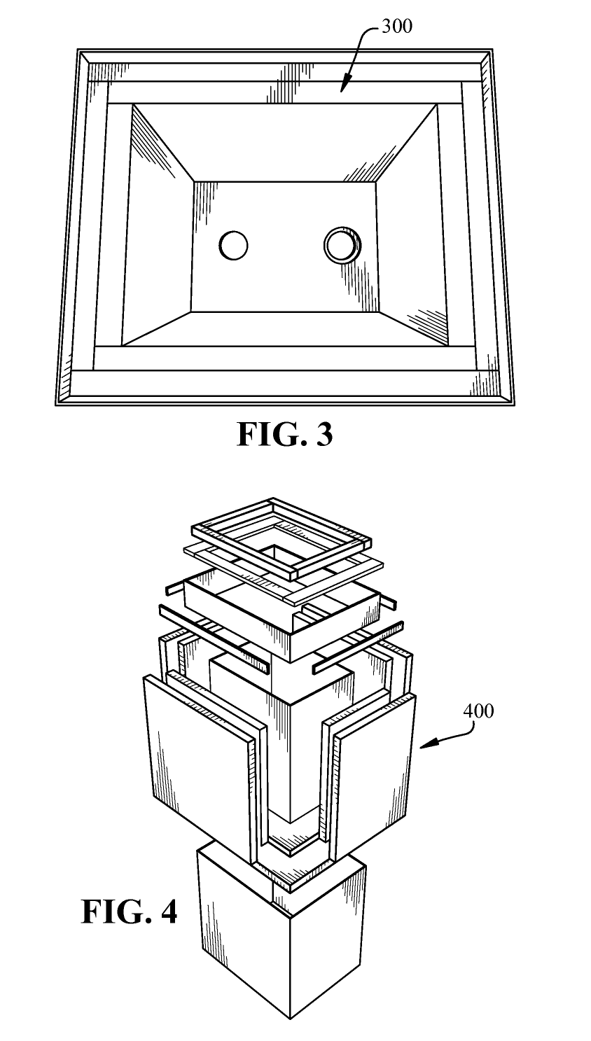

In between the two stainless steel rectangular frames are several layers (also referred to as panels) of micro-porous material 300 (FIG. 3) and 400 (FIG. 4). The panels' physical characteristics, which include a very low thermal conductivity coefficient, protect the internal equipment against fire. There are several of these panels inside the external frame 210 which have been specially designed to seal the space between the frames 210, 220.

In order to increase the protection against fire, there are several layers of intumescent seals and silicon foam. The benefit of these materials is that they expand when the temperature exceeds 100° C. In the event of a fire or excessive heat conditions, these materials in the main body of the data protection system will expand against the cover and the door, sealing the interior of the data protection device, hence guaranteeing the survival of the back-up data. A state-of-the-art fire protection has been developed specifically for the data protection system. It is a combination of the following four components:
1) intumescent tape
2) silicon foam (thickness 6 mm.) covering the intumescent tapes
3) silica cloth covering the 2 items above
4) components 1-3 are fixed by means of two steel L-shaped frames in order to keep them in position.

With the combination of these four components, the data protection system guarantees that the contact surfaces of both the frame (e.g., external and/or interior) and the door are properly insulated and protected against fire. As mentioned above, a desired component in a fire protection system is intumescent tape. Intumescent tape is made of an intumescent building material, which expands under the effect of rising temperatures (around 100° C.). After this tape expands, it forms a firm ceramic structure, sealing all the possible openings in the structure of the data protection system. Both rigid and flexible intumescent seals can be used, which are situated in specific locations, especially in the area(s) to where the fire will inevitably try to spread. These locations are the door seals, around the fans' ventilation ducts, at the rear cable gland, and the like.

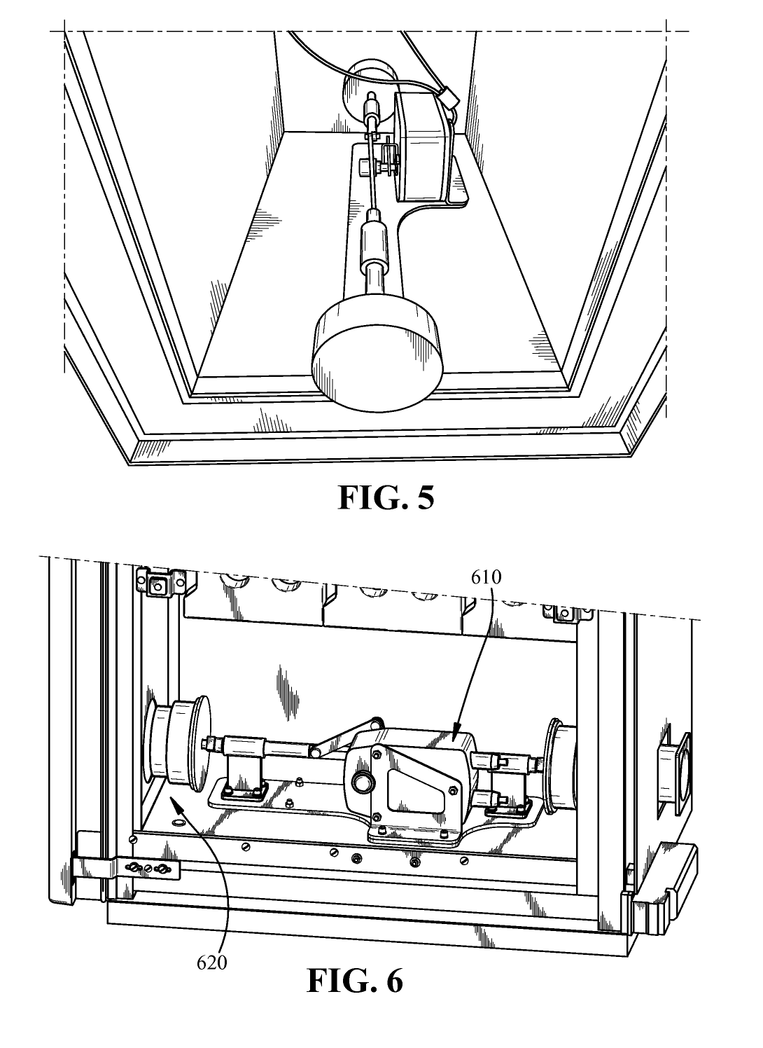

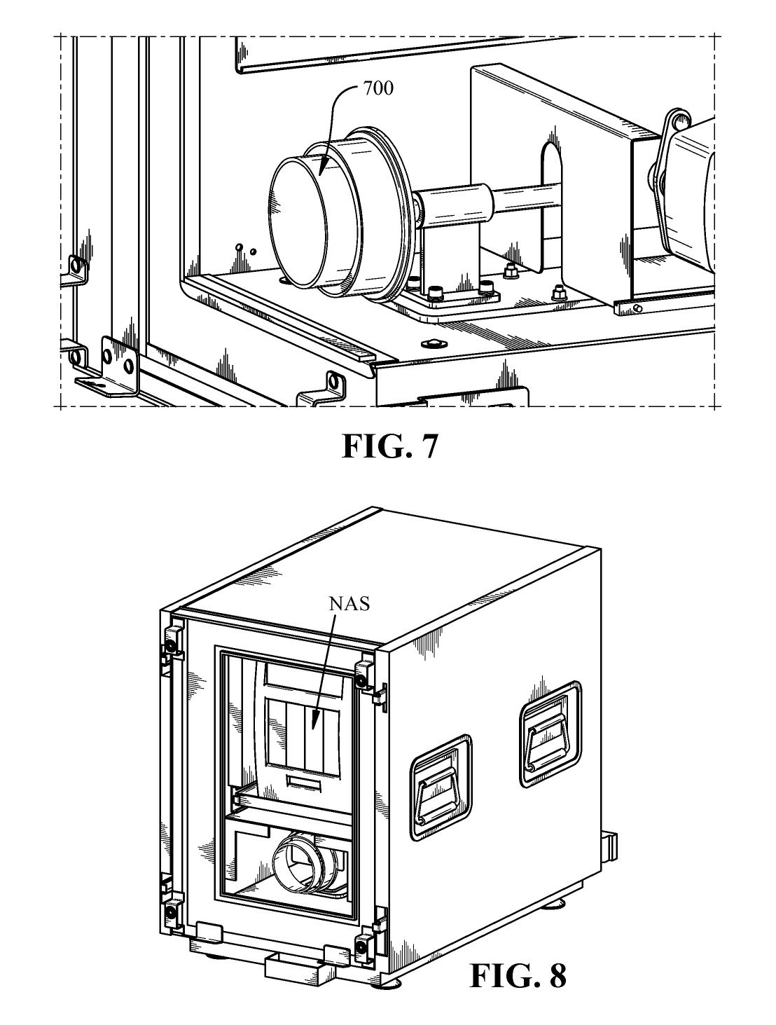

The stand-by or default position of the data protection system is with the door closed. But the air flow is guaranteed by way of the 6 internal fans, which cool the NAS inside. This air flow is controlled by a spring actuator 610, which is located at the bottom of the data protection system as illustrated in FIGS. 5 and 6. It has a cam device with one retractable axis on each side, at the end of which are attached the insulating plugs 620. The normal condition for this spring actuator is “retracted”, enabling an air flow through the inside of the data protection system. In the event of any alarm or shut-down conditions, the spring will actuate and the axis will extend. Following this longitudinal movement, the insulating plugs (620 in FIG. 6; 700 in FIG. 7) will close and seal the data protection system, making it tightened to any external threats (e.g., fire, vandalism, flood, vibration, etc . . . ).

The signal cables to switch on the spring actuator go through the back cable gland to the PC LINUX, located on the rear panel of the data protection system. The device activation can be triggered by any environmental parameters out of range or can be activated by the system administrator. This device has been specially developed to allow the air flow to cool the inside and ensure 100% that the data protection system will lock down in case of any alarm or abnormal conditions.

At the bottom of the data protection system there is a tube and a cable chain (not shown). An exemplary cable chain model is 07.20.018.0, from the manufacturer IGUS. The tube and the cable chain carry all the signal cables which link the rear part of the data protection system (where the PC LINUX, sensors, magnetic locks, etc . . . are located) to the front of the product (where the data board is installed). This cable chain is retractable and it allows the cables to follow the door movement every time the door closes or opens.

At the front of the data protection system, under the front cover, there are 4 mechanical locks, one on each corner. The purpose of these locks is to increase the extra security of the product, guaranteeing that the door is always locked. The data protection system is supplied with a special key to open these locks. It is recommended to the end user to use these locks every time that the door is opened and closed. By doing this, the back-up data inside is further protected against any external threats. In the event that an unauthorized attempt to open the locks is made and the doors happen to be left unlocked at the time, the magnetic locks at the back of the data protection system will still keep the door closed. If the door is forced, the vibrating sensor triggers an alarm, an SMS and/or email will be sent and the data protection system will lock down.

As mentioned above, the door 130 is attached to the main body (external frame) 210 of the data protection system through 2 pairs of guides to each side. The purpose of these guides is to allow the opening of the door and enable its smooth operation. An exemplary model of the guides is 3832 from the manufacturer ACCURITE. As mentioned before, 2 of these guides have attached to the end of them the pins which will engage with the magnetic locks.

The data protection system has been designed to stand on its own on top of its four reinforced legs or to be fitted inside any 19″ IT rack. In addition to the physical protection, one of the main benefits of the data protection system is its massive storage capacity by way of the NAS (Network Attached Storage) device (FIG. 8). The NAS device is located inside the internal tray of the data protection system and it is linked to a main network through a network cable connected to the customer's server. This NAS device allows any customer to expand their storage capacity while providing uninterrupted high performance data access across the local area network. It also allows remote monitoring of the environmental parameters inside and around the data protection system and of the disks backup status as well.

Inside the NAS are fitted 5 hard disks, for example, such as model ST3750640AS from the manufacturer SEAGATE. Each disk can have 750 GB capacity and are hot swappable. They can be configured in different RAIDS (level of redundancy) depending on the customer's requirements.

Under the front panel cover there is a data board, which can control and manage many different signals of the data protection system including but not limited to: flooding/moisture detection, fire detection, fans (which rotating speed can be monitored), ON/OFF switch, magnetic locks, power supply, GSM modem and an Embedded PC Linux. On the front panel cover, there can also be a tactile display, which shows environmental values such as temperature and relative humidity around the box in real time, the rotating speed of the monitored fans, etc.

Electrical components can be located on the rear panel of the data protection system. These components include but are not limited to the following: cable gland, 2 magnetic locks, power supply, fire detector, flood/moisture detector, embedded PC Linux, GSM Modem, ON/OFF switch, rear fan, and inlet filters.

The internal cables from the NAS (both power and network), the spring actuator, the internal fans, etc. are linked to the outside of the data protection system through a cable gland, located in the rear panel of the product. The physical characteristic of this cable gland makes it fire retardant. In the event of any extreme temperature, the cables will burn but the material itself will expand and become compact, delaying the action of the direct flame to the inside of the data protection system. A pair of insert blocks is used to surround each of the cables, compressing them to achieve a perfect tightness.

There are 2 magnetic locks assembled on the rear panel of the data protection system. An exemplary model is 440G-MT from the manufacturer ALLEN-BRADLEY. Looking at the product from behind, one is located on the top right corner and the other one on the bottom left corner. These are actuated electrically through the external power. A special key is provided to lock and unlock these devices. The magnetic locks will clamp the door when the user closes it, ensuring the physical protection of the internal elements. In order to do so, there are 2 special pins attached to the sliding guides which will engage with the magnetic locks. As the pins are attached to the guides, by closing the door it is guaranteed that the pins will clamp with the locks as well, ensuring a perfect clamping system. The magnetic locks are activated by electronic signals, and they can be triggered by any environmental parameters out of range or by the system administrator.

At the rear of the data protection system there is also a power supply. This is connected to some of the electrical components to provide power, i.e. embedded PC Linux, detectors and electronic/mechanical items. Also at the rear of the data protection system are 2 sensors: the flooding/moisture detector and the photo-thermal detector. They will send an alarm to the embedded PC Linux and the front data board in case any abnormal conditions are detected. If there are any of these abnormal conditions and depending on how the parameters have been preset, the data protection system will trigger an alarm and the data protection system will shut down.

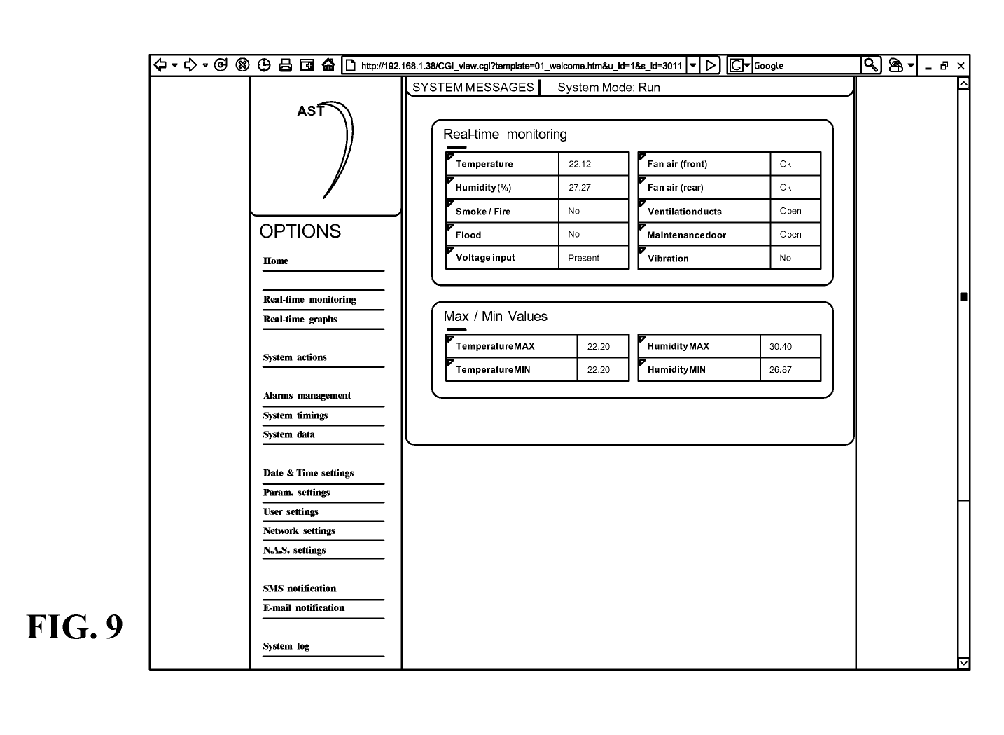

The state of these 2 sensors can be checked through a remote monitoring computer system. An exemplary user interface employed by the remote monitoring computer system is illustrated in FIG. 9.

The data protection system is managed, at least in part, by an embedded PC Linux. The PC Linux is in charge of managing all the logical functions supplied by the data board, the remote monitoring system and the website software. This device is the actuator which gives the order to send SMS messages, allows opening or closing the door, triggers the corresponding alarms or shuts down the whole system. The GSM modem can be preset to send an alarm SMS to up to 3 different mobile numbers, for example, in case any abnormal conditions are detected. The modem incorporates an antenna to provide good signal reception for sending these SMS messages.

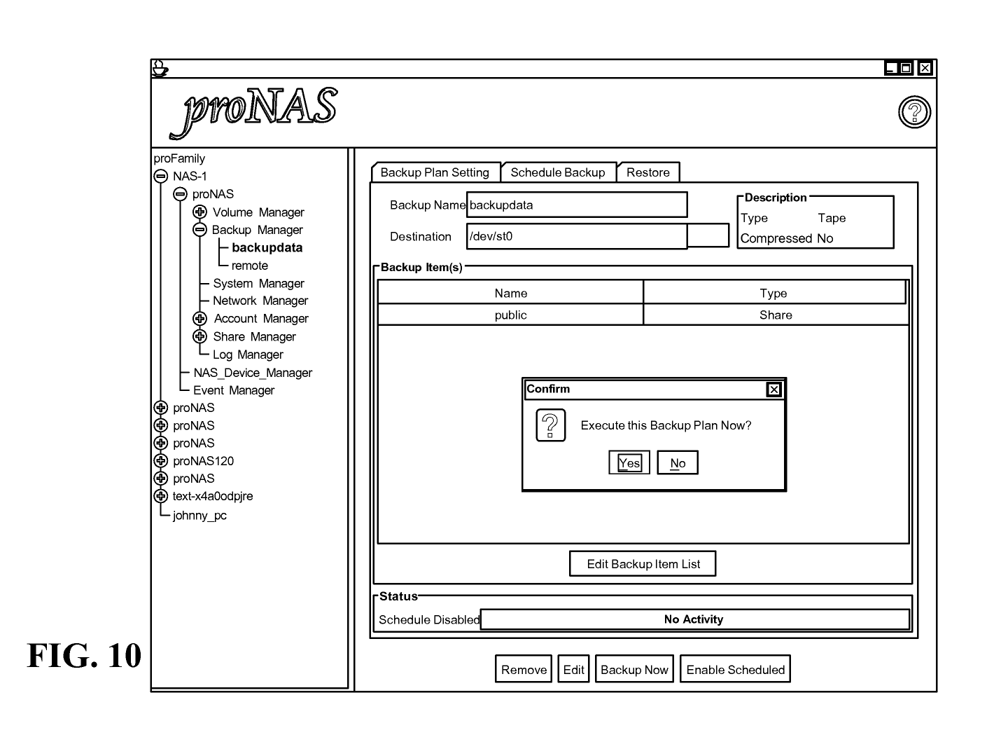

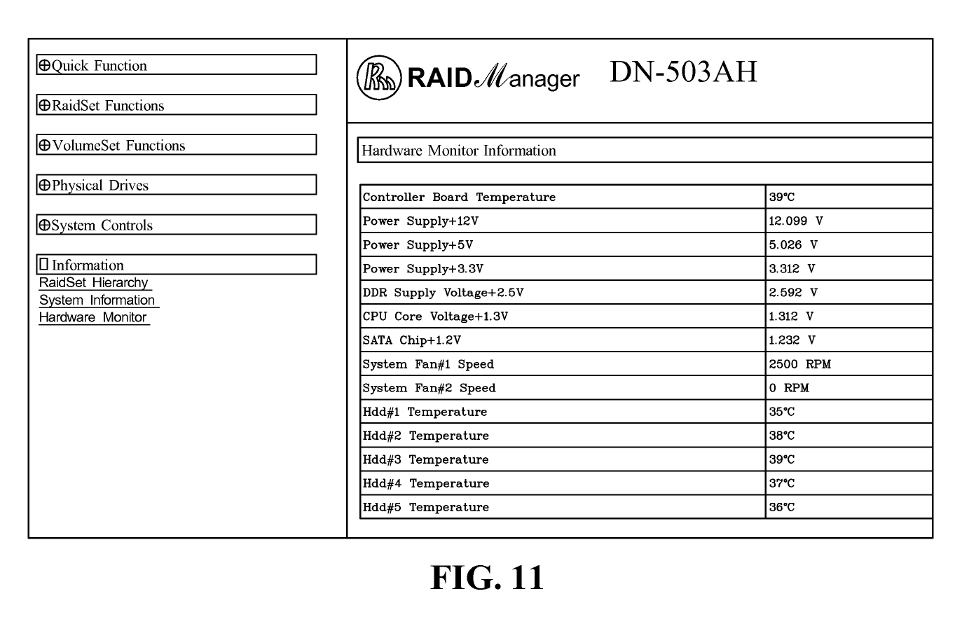

As mentioned above, the real-time state of disk backups as well as the status of the data protection system's hardware can be monitored remotely, in addition to remotely monitoring the environmental parameters of the data protection system. An exemplary user interface for each is depicted in FIGS. 10 and 11, respectively.

What has been described above includes examples of the subject system. It is, of course, not possible to describe every conceivable combination of components for purposes of describing the subject system, but one of ordinary skill in the art may recognize that many further combinations and permutations of the subject system are possible. Accordingly, the subject system is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A data protection device comprising:
an external frame;
at least one internal frame positioned inside of the external frame;
a plurality of layers comprising microporous material located between the external frame and the at least one internal frame such that the material fills the space between the external frame and the at least one internal frame;
a data storage system that is located within the at least one internal frame and that backs up data;
an online remote monitoring system located within the at least one internal frame that comprises a plurality of sensors and a data board, wherein the data board is connected to the plurality of sensors and wherein the data board remotely monitors in real-time at least one of the following parameters: temperature, back-up activity, access activity, relative humidity, vibration, fan speed, power supply, air quality, smoke, moisture, door status, lock status, ventilation duct status, electromagnetic radiation level, and system mode.

2. The device of claim 1, wherein the plurality of layers further comprise intumescent tape and silicon foam.

3. The device of claim 1, wherein the data storage component comprises one or more disks.

4. The device of claim 1 further comprises an integrated modem that sends at least one of an electronic message and a SMS alert when at least one of the following occurs: at least one parameter is outside a preset range or value or at least one alarm is triggered.

5. The device of claim 1, wherein the online remote monitoring system is accessible via a network which facilitates externally controlling one or more of the parameters.

6. The device of claim 1 further comprises a front cover which is attached to the external frame by way of sliding guides and a plurality of locking mechanisms that secure the front cover to the external frame and that sense the open or closed position of the front cover.

7. The device of claim 6 further comprises a tactile display that shows status information corresponding to one or more of the parameters.

8. The device of claim 2 further comprises a silica cloth that covers the intumescent tape and silicon foam, all of which are fixed by two steel L-shaped frames in order to maintain their position and protect the data storage component from damage.

9. The device of claim 1 wherein the plurality of layers seal any space between the external frame and the at least one internal frame.

10. The device of claim 1, wherein the data storage system is linked to a network that is connected to a server which facilitates expansion of storage capacity without interruption to access to previously stored data.

11. The device of claim 1, wherein the data board controls and manages a plurality of signals received from the plurality of sensors.

12. The device of claim 1, wherein the external frame is stainless steel.

13. The device of claim 1, wherein the at least one internal frame is stainless steel.

14. The device of claim 1, wherein the online remote monitoring system receives input to modify one or more parameters via a network interface.

15. The device of claim 14, wherein the network interface is web-based.

16. The device of claim 1 further comprises at least one of the following: a cooling system, thermostat, vibration gauge, humidity and moisture gauges, one or more fans, and locking mechanism.

17. The device of claim 1 further comprises insulating plugs that mate to openings in the interior frame that seal the interior frame to protect it from external elements including water, fire, smoke, and extreme exterior temperatures.
